(19) United States
(12) Patent Application Publication
(10) Pub. No.: US 2026/0342654 A1
(43) Pub. Date: Oct. 29, 2026

(54) SYSTEM AND METHOD FOR ON-DEVICE CONFIGURATION ACCOUNTING, AUDIT AND ROLLBACK

(71) Applicant: Dell Products L.P., Round Rock, TX (US)

(72) Inventors: Senthil Kumar Ganesan, San Ramon, CA (US); Venkatesan Mahalingam, Pleasanton, CA (US); Vinoth Kumar Arumugam, Fremont, CA (US); Udhayachandran Shanmugam, Santa Clara, CA (US)

(21) Appl. No.: 19/186,907

(22) Filed: Apr. 23, 2025

(51) Int. Cl. H04L 41/084; H04L 9/40; H04L 41/0853; H04L 41/0859

(52) U.S. Cl. CPC H04L 41/084; H04L 41/0853; H04L 41/0859; H04L 63/083

(57) ABSTRACT

A method for restoring a network switch to a desired configuration includes selecting, from a local version-controlled database, a first commit to initiate a reconfiguration to the desired configuration. The method also includes making a first determination that there is multiple commits required to achieve the desired configuration. Further, the method includes selecting, from the local version-controlled database, the commits. Moreover, the method includes merging the commits with the first commit to obtain a desired commit. Also, the method includes restoring the network switch to the desired configuration by applying the desired commit.

### BACKGROUND

Network fabric management is crucial to secure networks. However, existing approaches to network fabric management cannot track configuration changes efficiently or locally track configuration changes on a network switch over a period of time.

### BRIEF DESCRIPTION OF DRAWINGS

Certain embodiments of the disclosure will be described with reference to the accompanying drawings. However, the accompanying drawings illustrate only certain aspects or implementations of the disclosure by way of example and are not meant to limit the scope of the claims.

FIG. 1 shows a diagram of a system in accordance with one or more embodiments.

FIG. 2 shows a flowchart of a method for configuring a network switch with a latest commit in accordance with one or more embodiments.

FIG. 3 shows a flowchart of a method for committing a squashed configuration change to a local version-controlled database in accordance with one or more embodiments.

FIG. 4 shows a flowchart of a method for displaying recorded configuration commits made by each user in accordance with one or more embodiments.

FIG. 5 shows a flowchart of a method for restoring the network switch to a desired configuration by applying a desired commit in accordance with one or more embodiments.

FIG. 6 shows a computing system in accordance with one or more embodiments.

### DETAILED DESCRIPTION

In the landscape of network fabric management, traditional approaches to configuration tracking remain a significant challenge. Network fabric management involves managing and optimizing the underlying physical and virtual network infrastructure to ensure efficient, secure, and scalable communication and data transfer within a network. Further, the underlying software operating on the devices within the network fabric are constantly being updated to include new features and more robust security. However, maintaining the configuration of the software across the devices and managing issues that may arise presents a significant challenge at the scale of modern network fabrics (i.e., potentially thousands of interconnected devices).

A current approach to network fabric management is utilizing controller-based mechanisms. In this approach, a controller can set the devices (e.g., network switches) in the network fabric to read-only, enabling the controller to block configurations from other sources. This results in an inability to track real-time notifications and visibility into the changes made directly on the network switch, making it difficult to track unauthorized or manual modifications. Configuration changes are typically tracked only through basic methods such as command history (Terminal Access Controller Access-Control System Plus (TACACS+)/Radius), syslog, or accounting features found in protocols like AAA (Authentication, Authorization, and Accounting). Further, such tracking occurs outside of the network switches and thus can be challenging to detect if certain intended changes were actually made, undetected errors in the changes, or malicious changes that bypass the external tracking. However, these approaches are not comprehensive and often lack the depth needed for full auditing and validation.

Furthermore, there is currently no native method for tracking configuration changes on a network switch over time. This gap necessitates the use of external tools, such as controllers, version trackers, and/or accounting servers, as the network switch does not support this functionality. Monitoring configuration changes over time thus becoming fragmented and unreliable. Additionally, rolling back to a previous or desired configuration is difficult when multiple commits have been made, adding complexity and risk to network management and troubleshooting.

The limitations of the traditional approaches to network fabric management restrict the usability and potential improvement of tracking configuration changes. For at least the reasons discussed above, a fundamentally different approach is needed to address these challenges. Embodiments herein relate to a method for restoring a network switch to a desired configuration. As a result of the processes discussed below, one or more embodiments disclosed herein introduce a local version-controlled database (e.g., Dolt) docker within the network switch to track configuration changes. The local database repository may be connected and synced with a remote database for network fabric-level configuration management. By utilizing the local version-controlled database, commands are seamlessly auto-committed internally to the database along with context and user credentials. Further, subsequent configuration changes are immediately committed to the database upon successful execution of individual commands and squashed periodically. If any commit results in undesired behavior, a database revert operation may be executed to rebase to a specific commit, thereby restoring the network switch to the configuration defined by that commit. Moreover, one or more embodiments disclosed herein advantageously ensure that users will be able to cherry-pick specific commits to rollback to a desired configuration.

Specific embodiments will now be described with reference to the accompanying figures.

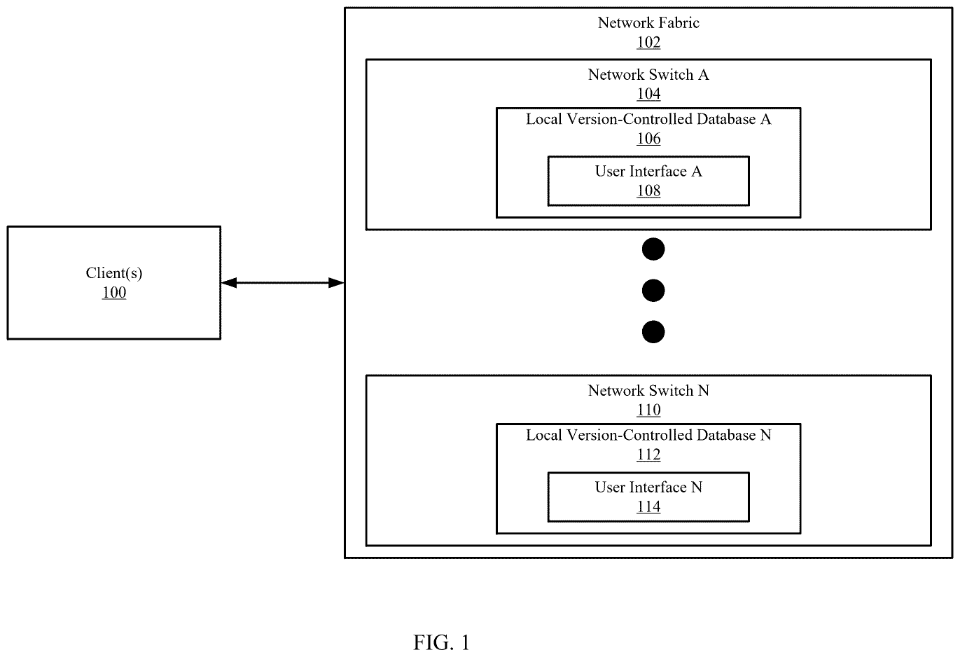

FIG. 1 shows a system in accordance with one or more embodiments. The system may include any number of clients (100) and a network fabric (102). In one or more embodiments, the network fabric (102) includes any number of network switches (e.g., 104 and 110). Each network switch (e.g., 104 and 110) further includes a respective local version-controlled database (e.g., 106 and 112). In one or more embodiments, each local version-controlled database (e.g., 106 and 112) further includes a user interface (e.g., 108 and 114). The client(s) (100) and the network fabric (102) may communicate through an internal network or by other means. The system may include additional, fewer, and/or different components without departing from the scope disclosed herein. Each component may be operably/operatively connected to any of the other components via any combination of wired and/or wireless connections. Each of these system components is described below.

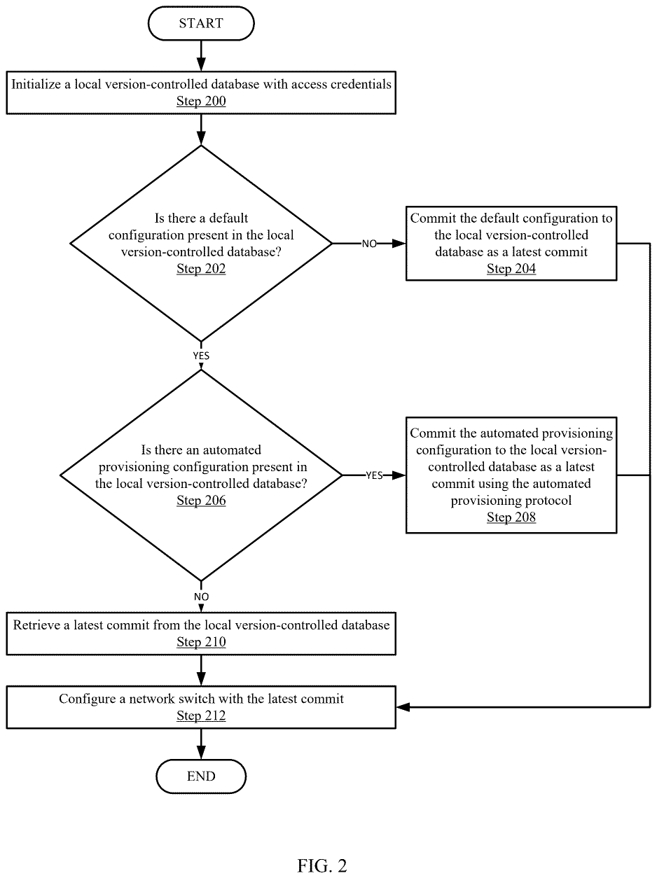

In one or more embodiments, the client(s) (100) includes functionality to permit users to interact with the network fabric (102). Further, the client(s) (100) includes functionality to perform at least a portion of the method shown in FIGS. 2-5. One of ordinary skill will appreciate that the client(s) (100) may perform other functionalities without departing from the scope disclosed herein.

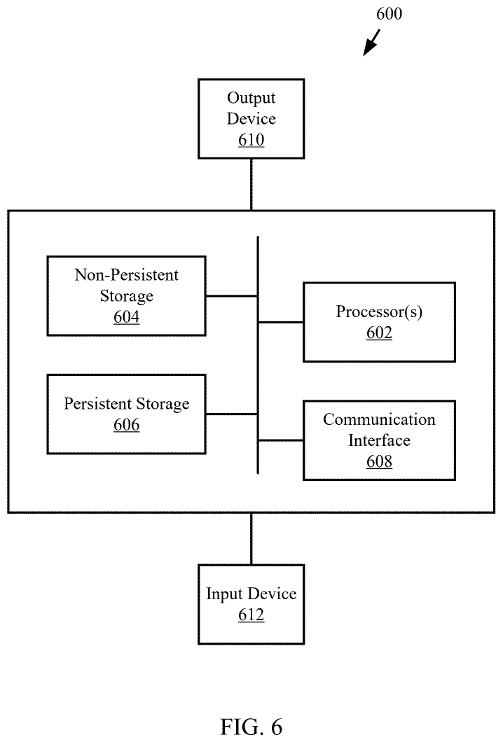

In one or more embodiments disclosed herein, the client(s) (100) may be a physical device or a virtual device (i.e., a virtual machine executing on one or more physical devices) such as a personal computing system (e.g., a laptop, a cell phone, a tablet computer, a virtual machine executing on a server, etc.) of a user. For example, the client(s) (100) may be a computing system (e.g., 600, FIG. 6), as discussed below in more detail in FIG. 6.

In one or more embodiments, the network fabric (102) includes functionality to facilitate data transfer between connected components (e.g., network switch A (104) and network switch N (110)). Said another way, a network switch (e.g., 104 and 110) may both transmit and receive data from the same pathway facilitated by the network fabric (102). The network fabric (102) may also include the functionality to identify network congestion via the switches. Further, in one or more embodiments, the network fabric (102) consists of multiple segments where each connection between two network switches in the network fabric is a segment. As a non-limiting example, data traveling between network switch A (104) and network switch N (110) would travel across segment A-N. Further, the network fabric (102) includes functionality to perform at least a portion of the method shown in FIGS. 2-5. One of ordinary skill will appreciate that the network fabric (102) may perform other functionalities without departing from the scope disclosed herein.

In one or more embodiments, the network switches (e.g., 104 and 110) represent physical, high-performance devices configured to connect network servers, storage devices, and other network appliances within enterprise (e.g., on-premises and/or cloud computing infrastructure) environments. This connection between enterprise environment elements may be implemented over one or more networks (e.g., local area networks (LANs), wide area networks (WANs) such as the Internet, mobile networks, etc.). Further, the network switches (e.g., 104 and 110) includes functionality to perform at least a portion of the method shown in FIGS. 2-5. One of ordinary skill will appreciate that the network switches (e.g., 104 and 110) may perform other functionalities without departing from the scope disclosed herein.

In one or more embodiments, the local version-controlled database (e.g., 106 and 112) includes functionality to record and audit configuration changes made by a user to a network switch (e.g., 104 and 110). In one or more embodiments, the local version-controlled database (e.g., 106 and 112) tracks the reason for each configuration change, the timestamp of each configuration change, and when the configuration change was pushed to the network switch (e.g. 104 and 110). Further, the local version-controlled database (e.g., 106 and 112) includes functionality to perform at least a portion of the method shown in FIGS. 2-5. In one or more embodiments, the local version-controlled database (e.g., 106 and 112) includes storage and/or memory resources to perform its functionality. One of ordinary skill will appreciate that the local version-controlled database (e.g., 106 and 112) may perform other functionalities without departing from the scope disclosed herein.

In one or more embodiments, a storage or memory resource (not shown) may refer to a measurable quantity of a storage/memory-relevant resource type, which can be requested, allocated, and consumed. A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), an SSD, RAM, Flash memory, a tape drive, an FC-based storage device, a floppy disk, a diskette, a compact disc (CD), a digital versatile disc (DVD), a NVMe device, a NVMe over Fabrics (NVMe-oF) device, resistive RAM (ReRAM), persistent memory (PMEM), virtualized storage, virtualized memory, etc.

As used herein, “storage” refers to a hardware component that is used to store data in a client. Storage may be a physical computer-readable medium. In most cases, storage may be configured as a storage array (e.g., a network attached storage array), in which a storage array may refer to a collection of one or more physical storage devices. Each physical storage device may include non-transitory computer-readable storage media, in which the data may be stored in whole or in part, and temporarily or permanently.

As used herein, “memory” may be any hardware component that is used to store data in a client. The data stored may be accessed almost instantly (e.g., in milliseconds) regardless of where the data is stored in memory. The memory may provide the above-mentioned instant data access because the memory may be directly connected to a CPU on a wide and fast bus (e.g., a high-speed internal connection that transfers data among hardware components of a client).

In one or more embodiments, the user interface (e.g., 108 and 114) includes functionality to facilitate communications between the local version-controlled database (e.g. 106 and 112) and the client(s) (100). In one or more embodiments, the user interface (e.g., 108 and 114) includes functionality to display recorded configuration commits made by each user upon an audit request made by a user with relevant access credentials. Further, the user interface (e.g., 108 and 114) includes functionality to perform at least a portion of the method shown in FIGS. 2-5. One of ordinary skill will appreciate that the user interface (e.g., 108 and 114) may perform other functionalities without departing from the scope disclosed herein.

In one or more embodiments, the network switches (e.g., 104 and 110) are implemented as a computing device (e.g., 600, FIG. 6). The computing device may be, for example, a mobile phone, a tablet computer, a laptop computer, a desktop computer, a server, a distributed computing system, or a cloud resource. The computing device may include one or more processors, memory (e.g., random access memory (RAM)), and persistent storage (e.g., disk drives, solid-state drives (SSDs), etc.). The computing device may include instructions, stored in the persistent storage, that when executed by the processor(s) of the computing device cause the computing device to perform the functionality of the network switches described throughout this application.

Alternatively, in one or more embodiments, network switches (e.g., 104 and 110), the local version-controlled database (e.g., 106 and 112), and/or the user interface (e.g., 108 and 114) may be implemented as a logical device. The logical device may utilize the computing resources of any number of computing devices to provide the functionality of the source device (110), the target device (120) and/or the server module (130) described herein.

Turning to FIG. 2, FIG. 2 shows a flowchart of a method for configuring a network switch with the latest commit in accordance with one or more embodiments. The method may be performed by, for example, the network fabric (102, FIG. 1).

While the various steps in the flowchart shown in FIG. 2 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 200, a local version-controlled database (e.g., 106 and 112, FIG. 1) is initialized with access credentials. In one or more embodiments, the local version-controlled database (e.g., 106 and 112, FIG. 1) is also initialized with optional remote database connectivity to maintain network fabric level configurations.

In step 202, a determination is made as to whether there is a default configuration present in the local version-controlled database (e.g., 106 and 112, FIG. 1). In one or more embodiments, a default configuration refers to a designated initial configuration for the network switches. In one or more embodiments, this default configuration is a pre-loaded configuration and may include a configuration set by a manufacturer. In one or more embodiments, if a default configuration does not exist, a default configuration may be generated based on platform details (i.e., the model and manufacturer of the network switch). Accordingly, in one or more embodiments, if the result of this determination is NO, the method proceeds to step 204. Alternatively, if the result of this determination is YES, the method may proceed to step 206.

In step 204, after it has been determined that there is not a default configuration present in the local version-controlled database (e.g., 106 and 112, FIG. 1), the default configuration is committed to the local version-controlled database (e.g., 106 and 112, FIG. 1) as a latest commit. In one or more embodiments, the latest commit refers to the most recent commit made to the network switch (e.g., 104 and 110, FIG. 1). Said another way, the latest commit is the latest configuration change made to the network switch (e.g., 104 and 110, FIG. 1). The method may proceed to step 212 after step 204.

In step 206, after it has been determined that there is a default configuration present in the local version-controlled database (e.g., 106 and 112, FIG. 1), a determination is made as to whether there is an automated provisioning configuration present in the local version-controlled database (e.g., 106 and 112, FIG. 1). In one or more embodiments, an automated provisioning configuration may be zero-touch provisioning (ZTP). ZTP is an automated process that configures a network switch (e.g., 104 and 110, FIG. 1) by using communication protocols with other network switches to obtain a configuration, all without requiring any interaction from a user. It aims to completely eliminate manual intervention during the initial setup and configuration of network switches (e.g., 104 and 110, FIG. 1). Accordingly, in one or more embodiments, if the result of this determination is YES, the method proceeds to step 208. Alternatively, if the result of this determination is NO, the method may proceed to step 210.

In step 208, after it has been determined that an automated provisioning configuration is present in the local version-controlled database (e.g., 106 and 112, FIG. 1), the automated provisioning configuration is committed to the local version-controlled database (e.g., 106 and 112, FIG. 1) as a latest commit using the automated provisioning protocol. The automated provisioning protocol is a specific standard or method used to automate the provisioning process. The method may proceed to step 212 after step 208.

In step 210, after it has been determined that there is not an automated provisioning configuration present in the local version-controlled database (e.g., 106 and 112, FIG. 1), a latest commit is retrieved from the local version-controlled database (e.g., 106 and 112, FIG. 1). In one or more embodiments, the latest commit may be the default configuration, the automated provisioning configuration, or another configuration change made to the network switch (e.g., 104 and 110, FIG. 1). In one or more embodiments, the local version-controlled database (e.g., 106 and 112, FIG. 1) monitors every configuration change to the network switch (e.g., 104 and 110, FIG. 1) and commits it to the database for tracking.

In step 212, a network switch (e.g., 104 and 110, FIG. 1) is configured with the latest commit. In one or more embodiments, the network switch is configured with the latest configuration change made by a user.

The method may end following step 212.

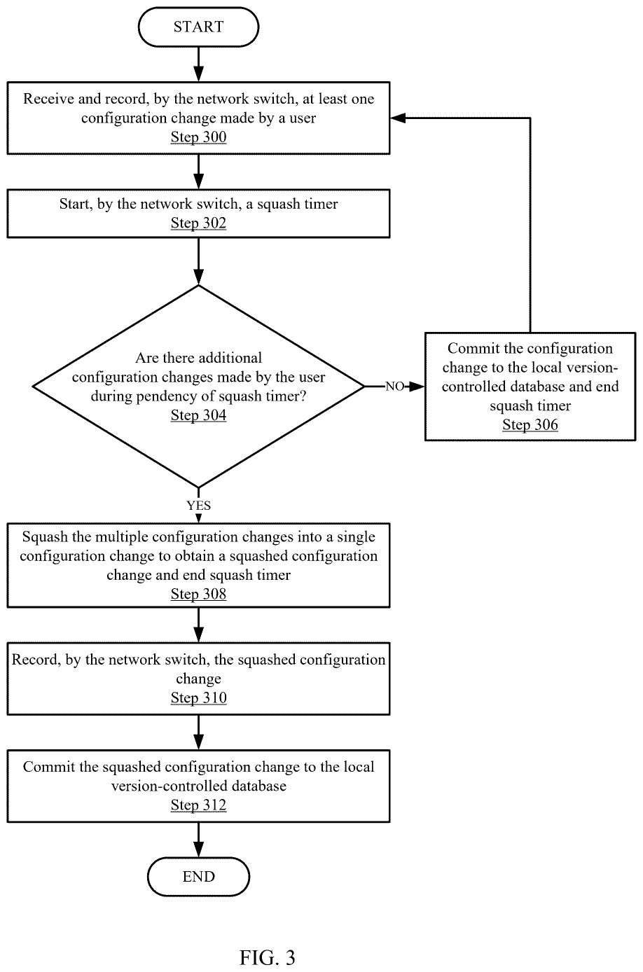

Turning to FIG. 3, FIG. 3 shows a flowchart of a method for committing the squashed configuration change to the local version-controlled database in accordance with one or more embodiments. In one or more embodiments, the method presented in FIG. 3 is performed recursively such that the network switch (e.g., 104 and 110, FIG. 1) is constantly monitoring and recording the configuration changes made by users. The method may be performed by, for example, the network fabric (102, FIG. 1).

While the various steps in the flowchart shown in FIG. 3 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 300, at least one configuration change made by a user is received and recorded by the network switch (e.g., 104 and 110, FIG. 1). In one or more embodiments, the configuration change made by the user can be made directly to the network switch, via a controller to the network switch, or via another network switch to the network switch.

In step 302, a squash timer is started by the network switch (e.g., 104 and 110, FIG. 1). In one or more embodiments, the squash timer is used to track the application of configuration changes on a network switch for a predefined period. In one or more embodiments, the user (e.g., via a client(s) (100, FIG. 1)) may configure the duration of the squash timer.

In step 304, a determination is made as to whether there are additional configuration changes made by the user during the pendency of the squash timer. Accordingly, in one or more embodiments, if the result of this determination is YES, the method proceeds to step 308. Alternatively, if the result of this determination is NO, the method may proceed to step 306.

In step 306, after it has been determined that there are no additional configuration changes made by the user during the pendency of the squash timer, the at least one configuration change received in step 300 is committed to the local version-controlled database (e.g., 106 and 112, FIG. 1) and the squash timer is ended. In one or more embodiments, the squash timer is ended by the network switch (e.g., 104 and 110, FIG. 1). After step 306, the method may proceed back to step 300.

In step 308, after it has been determined that there has been additional changes made by the user during the pendency of the squash timer, the multiple configuration changes are squashed into a single configuration change to obtain a squashed configuration change. As such, these multiple configuration changes are treated as a single configuration change, thereby conserving storage resources and reducing the time to audit the configuration changes by reducing the number of potential configuration changes available for audit. Additionally, in step 308, the squash timer is ended. In one or more embodiments, the squash timer is ended by the network switch (e.g., 104 and 110, FIG. 1).

In step 310, the squashed configuration change is recorded by the network switch (e.g., 104 and 110, FIG. 1).

In step 312, the squashed configuration change is committed to the local version-controlled database (e.g., 106 and 112, FIG. 1). In one or more embodiments, the commitment of the configuration change further includes metadata relating to the configuration change, including version numbers, users associated with the configuration change, the time at which the configuration change was made, in what manner the configuration change was made, etc.

The method may end following step 312.

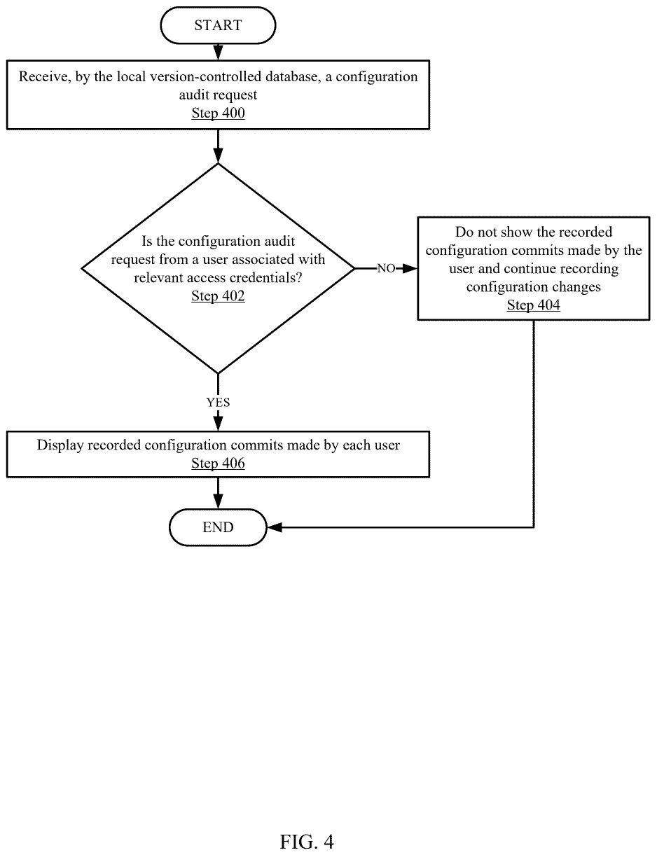

Turning to FIG. 4, FIG. 4 shows a flowchart of a method for displaying recorded configuration commits made by each user in accordance with one or more embodiments. The method described below enables a configuration audit trail feature for the network switch (e.g., 104 and 110, FIG. 1). As a non-limiting example, a user via a client (100, FIG. 1) may need to audit the network switch (e.g., 104 and 110, FIG. 1) by manually reviewing the configuration commits made by each user over time. The user may then audit each commit accordingly that is present in the final configuration. The method presented in FIG. 4 assists in auditing which user made which specific changes, making it easier to revert or roll back to a desired configuration, if needed. The method may be performed by, for example, the network fabric (102, FIG. 1).

While the various steps in the flowchart shown in FIG. 4 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 400, a configuration audit request is received by the local version-controlled database. In one or more embodiments, the configuration audit request may be provided by a user via a client (e.g., 100, FIG. 1).

In step 402, a determination is made as to whether the configuration audit request is from a user associated relevant access credentials. In one or more embodiments, a user associated with relevant access credentials may make configuration changes to the network switch (e.g., 104 and 110, FIG. 1). Accordingly, in one or more embodiments, if the result of this determination is NO, the method proceeds to step 404. Alternatively, if the result of this determination is YES, the method may proceed to step 406.

In step 404, after it has been determined that the configuration audit request is from a user not associated with relevant access credentials, the recorded configuration commits made by the user are prohibited from being displayed. Additionally, in step 404, configuration changes continue to be recorded. The method may end following step 404.

In step 406, after it has been determined that the configuration audit request is from a user associated with relevant access credentials, the recorded configuration commits made by each user are displayed. In one or more embodiments, the recorded configuration commits are displayed via the user interface (e.g., 108 and 114, FIG. 1). Further, in one or more embodiments, the display of the configuration commits includes: metadata associated with each of the configuration commits, an input for searching for configuration commits which may filter results in real-time, options to sort the configuration commits based on the associated metadata which may automatically reorder the configuration commits, etc.

The method may end following step 406.

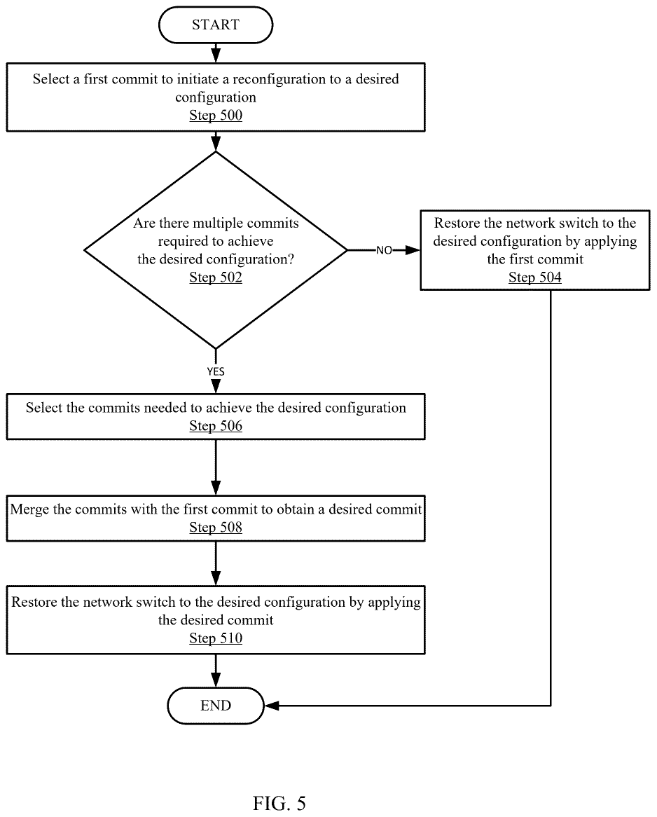

Turning to FIG. 5, FIG. 5 shows a flowchart of a method for restoring the network switch to the desired configuration by applying the desired commit in accordance with one or more embodiments. The method presented in FIG. 5 enables users to pick commits from multiple revisions to build a desired commit to establish a desired configuration of the network switch (e.g., 104 and 110, FIG. 1). The method may be performed by, for example, the network fabric (102, FIG. 1).

While the various steps in the flowchart shown in FIG. 5 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 500, a first commit is selected to initiate a reconfiguration to a desired configuration. In one or more embodiments, a user via a client (e.g., client (100, FIG. 1)) chooses the desired configuration. In one or more embodiments, the first commit may be a commit that reflects the default configuration of the network switch (e.g., 104 and 110, FIG. 1). In one or more embodiments, the first commit may also be the most recent commit made to the network switch (e.g., 104 and 110, FIG. 1).

In step 502, a determination is made as to whether there are multiple commits required to achieve the desired configuration. In one or more embodiments, the desired commit is a previously made commit. This previously made commit may be the most recent, previously made commit in which case there would only be a single commit required to achieve the desired configuration. However, if the previously made commit has one or more commits between the current configuration and the desired configuration, then it is determined that there are multiple commits required to achieve the desired configuration. Accordingly, in one or more embodiments, if the result of this determination is NO, the method proceeds to step 504. Alternatively, if the result of this determination is YES, the method may proceed to step 506.

In step 504, after it has been determined that there is not multiple commits required to achieve the desired configuration, the network switch is restored to the desired configuration by applying the first commit. In one or more embodiments, additional commits were not needed to establish desired configuration. The method may end following step 504.

In step 506, after it has been determined there is are multiple commits required to achieve the desired configuration, the commits needed to achieve the desired configuration are selected. In one or more embodiments, the commits are selected by the user. In one or more embodiments, the user selects important commits on top of the first commit to establish the desired configuration. In one or more embodiments, the user may also identify a commit that is causing a problem in the network switch (e.g., 104 and 110, FIG. 1) and revert the problematic commit from a group of commits, effectively removing the problematic commit to achieve the desired configuration. Problematic commits may also be known as blame features of the network switch (e.g., 104 and 110, FIG. 1).

In step 508, the commits are merged with the first commit to obtain a desired commit. In one or more embodiments, the desired commit reflects the desired configuration chosen by the user.

In step 510, the network switch is restored to the desired configuration by applying the desired commit.

The method may end following step 510.

Embodiments of the disclosure may be implemented using computing devices. FIG. 6 shows a diagram of a computing device (600) in accordance with one or more embodiments. The computing device (600) may include one or more computer processors (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (608) (e.g., Bluetooth interface, infrared interface, network interface, optical interface, etc.), input devices (612), output devices (610), and numerous other elements (not shown) and functionalities. Each of these components is described below.

In one embodiment, the computer processor(s) (602) may be an integrated circuit for processing instructions. For example, the computer processor(s) (602) may be one or more cores or micro-cores of a processor. The computing device (600) may also include one or more input devices (612), such as a touchscreen, keyboard, mouse, microphone, touchpad, electronic pen, or any other type of input device. The communication interface (608) may include an integrated circuit for connecting the computing device (600) to a network (not shown) (e.g., a local area network (LAN), a wide area network (WAN) such as the Internet, mobile network, or any other type of network) and/or to another device, such as another computing device.

In one embodiment, the computing device (600) may include one or more output devices (610), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) (612, 610) may be locally or remotely connected to the computer processor(s) (602), nonpersistent storage (604), and persistent storage (606). Many diverse types of computing devices exist, and the aforementioned input and output device(s) (612, 610) may take other forms.

The problems discussed above should be understood as being examples of problems solved by embodiments of the disclosure and the disclosure should not be limited to solving the same/similar problems. The disclosed disclosure is broadly applicable to address a range of problems beyond those discussed herein.

In the detailed description of the embodiments, numerous specific details are set forth in order to provide a more thorough understanding of one or more embodiments. However, it will be apparent to one of ordinary skill in the art that the one or more embodiments may be practiced without these specific details. In other instances, well-known features have not been described in detail to avoid unnecessarily complicating the description.

In the prior description of the figures, any component described with regard to a figure, in various embodiments, may be equivalent to one or more likenamed components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for restoring a network switch to a desired configuration, the method comprising:
selecting, from a local version-controlled database, a first commit to initiate a reconfiguration to the desired configuration;
making a first determination that there is a plurality of commits required to achieve the desired configuration;
selecting, from the local version-controlled database, the plurality of commits;
merging the plurality of commits with the first commit to obtain a desired commit; and
restoring the network switch to the desired configuration by applying the desired commit.

2. The method of claim 1, the method further comprising:
prior to selecting, from the local version-controlled database, the first commit to initiate the reconfiguration to the desired configuration:
initializing the local version-controlled database with access credentials;
making a second determination that there is a default configuration present in the local version-controlled database;
making a third determination, based on the second determination, that there is not an automated provisioning configuration present in the local version-controlled database;
retrieving, based on the third determination, a latest commit from the local version-controlled database; and
configuring the network switch with the latest commit.

3. The method of claim 2, the method further comprising:
after configuring the network switch with the latest commit:
receiving and recording, by the network switch, a configuration change made by a first user;
starting, by the network switch and in response to receiving and recording, a squash timer;
making a fourth determination that there has been at least one additional configuration change made by the first user during a pendency of the squash timer;
squashing, based on the fourth determination, the configuration change and the at least one additional configuration change into a single configuration change to obtain a squashed configuration change;
ending, based on the fourth determination, the squash timer;
recording, by the network switch, the squashed configuration change; and
committing the squashed configuration change to the local version-controlled database.

4. The method of claim 3, the method further comprising:
after committing the squashed configuration change to the local version-controlled database:
receiving, by the local version-controlled database, a configuration audit request;
making a fifth determination the configuration audit request is from a second user associated with relevant access credentials; and
displaying each recorded configuration commit made by each user stored on the local version-controlled database.

5. The method of claim 3, the method further comprising:
after committing the squashed configuration change to the local version-controlled database:
receiving, by the local version-controlled database, a configuration audit request;
making a sixth determination that a second user is not associated with relevant access credentials; and
sending, based on the sixth determination, an alert to an administrator.

6. The method of claim 2, the method further comprising:
after configuring the network switch with the latest commit:
receiving and recording, by the network switch, a configuration change made by a first user;
starting, by the network switch and in response to receiving and recording, a squash timer;
making a seventh determination that there has not been at least one additional configuration change made by the first user during a pendency of the squash timer;
committing the configuration change to the local version-controlled database; and
restarting the squash timer.

7. The method of claim 1, wherein the method further comprises:
prior to selecting, from the local version-controlled database, the first commit to initiate the reconfiguration to the desired configuration:
initializing the local version-controlled database with access credentials;
making an eighth determination that there is not a default configuration present in the local version-controlled database;
committing the default configuration to the local version-controlled database as a second latest commit; and
configuring the network switch with the second latest commit.

8. The method of claim 1, wherein the method further comprises:
prior to selecting, from the local version-controlled database, the first commit to initiate the reconfiguration to the desired configuration:
initializing the local version-controlled database with access credentials;
making a ninth determination that there is a default configuration present in the local version-controlled database;
making a tenth determination, based on the ninth determination, that there is an automated provisioning configuration present in the local version-controlled database;
committing, using an automated provisioning protocol, the automated provisioning configuration to the local version-controlled database as a third latest commit; and
configuring the network switch with the third latest commit.

9. A non-transitory computer readable medium (CRM) comprising computer readable program code, which when executed by a computer processor, enables the computer to perform a method for restoring a network switch to a desired configuration, the method comprising:
selecting, from a local version-controlled database, a first commit to initiate a reconfiguration to the desired configuration;
making a first determination that there is a plurality of commits required to achieve the desired configuration;
selecting, from the local version-controlled database, the plurality of commits;
merging the plurality of commits with the first commit to obtain a desired commit; and
restoring the network switch to the desired configuration by applying the desired commit.

10. The non-transitory CRM of claim 9, the method further comprising:
prior to selecting, from the local version-controlled database, the first commit to initiate the reconfiguration to the desired configuration:
initializing the local version-controlled database with access credentials;
making a second determination that there is a default configuration present in the local version-controlled database;
making a third determination, based on the second determination, that there is not an automated provisioning configuration present in the local version-controlled database;
retrieving, based on the third determination, a latest commit from the local version-controlled database; and
configuring the network switch with the latest commit.

11. The non-transitory CRM of claim 10, the method further comprising:
after configuring the network switch with the latest commit:
receiving and recording, by the network switch, a configuration change made by a first user;
starting, by the network switch and in response to receiving and recording, a squash timer;
making a fourth determination that there has been at least one additional configuration change made by the first user during a pendency of the squash timer;
squashing, based on the fourth determination, the configuration change and the at least one additional configuration change into a single configuration change to obtain a squashed configuration change;
ending, based on the fourth determination, the squash timer;
recording, by the network switch, the squashed configuration change; and
committing the squashed configuration change to the local version-controlled database.

12. The non-transitory CRM of claim 11, the method further comprising:
after committing the squashed configuration change to the local version-controlled database:
receiving, by the local version-controlled database, a configuration audit request;
making a fifth determination the configuration audit request is from a second user associated with relevant access credentials; and
displaying each recorded configuration commit made by each user stored on the local version-controlled database.

13. The non-transitory CRM of claim 11, the method further comprising:
after committing the squashed configuration change to the local version-controlled database:
receiving, by the local version-controlled database, a configuration audit request;
making a sixth determination that a second user is not associated with relevant access credentials; and
sending, based on the sixth determination, an alert to an administrator.

14. The non-transitory CRM of claim 10, the method further comprising:
after configuring the network switch with the latest commit:
receiving and recording, by the network switch, a configuration change made by a first user;
starting, by the network switch and in response to receiving and recording, a squash timer;
making a seventh determination that there has not been at least one additional configuration change made by the first user during a pendency of the squash timer;
committing the configuration change to the local version-controlled database; and
restarting the squash timer.

15. The non-transitory CRM of claim 9, wherein the method further comprises:
prior to selecting, from the local version-controlled database, the first commit to initiate the reconfiguration to the desired configuration:
initializing the local version-controlled database with access credentials;
making an eighth determination that there is not a default configuration present in the local version-controlled database;
committing the default configuration to the local version-controlled database as a second latest commit; and
configuring the network switch with the second latest commit.

16. A system, the system comprising:
a network fabric, wherein the network fabric comprises a plurality of network switches and a plurality of local version-controlled databases;
at least one processor; and
at least one memory that includes instructions, which when executed by the processor, performs a method for restoring a network switch to a desired configuration, the method comprising:
selecting, from a local version-controlled database, a first commit to initiate a reconfiguration to the desired configuration;
making a first determination that there is a plurality of commits required to achieve the desired configuration;
selecting, from the local version-controlled database, the plurality of commits;
merging the plurality of commits with the first commit to obtain a desired commit; and
restoring the network switch to the desired configuration by applying the desired commit.

17. The system of claim 16, the method further comprising:
prior to selecting, from the local version-controlled database, the first commit to initiate the reconfiguration to the desired configuration:
initializing the local version-controlled database with access credentials;
making a second determination that there is a default configuration present in the local version-controlled database;
making a third determination, based on the second determination, that there is not an automated provisioning configuration present in the local version-controlled database;
retrieving, based on the third determination, a latest commit from the local version-controlled database; and
configuring the network switch with the latest commit.

18. The system of claim 17, the method further comprising:
after configuring the network switch with the latest commit:
receiving and recording, by the network switch, a configuration change made by a first user;
starting, by the network switch and in response to receiving and recording, a squash timer;
making a fourth determination that there has been at least one additional configuration change made by the first user during a pendency of the squash timer;
squashing, based on the fourth determination, the configuration change and the at least one additional configuration change into a single configuration change to obtain a squashed configuration change;
ending, based on the fourth determination, the squash timer;
recording, by the network switch, the squashed configuration change; and
committing the squashed configuration change to the local version-controlled database.

19. The system of claim 18, the method further comprising:
after committing the squashed configuration change to the local version-controlled database:
receiving, by the local version-controlled database, a configuration audit request;
making a fifth determination the configuration audit request is from a second user associated with relevant access credentials; and
displaying each recorded configuration commit made by each user stored on the local version-controlled database.

20. The system of claim 16, wherein the method further comprises:
prior to selecting, from the local version-controlled database, the first commit to initiate the reconfiguration to the desired configuration:
initializing the local version-controlled database with access credentials;
making a sixth determination that there is a default configuration present in the local version-controlled database;
making a seventh determination, based on the sixth determination, that there is an automated provisioning configuration present in the local version-controlled database;
committing, using an automated provisioning protocol, the automated provisioning configuration to the local version-controlled database as a second latest commit; and
configuring the network switch with the second latest commit.
